(19) United States
(12) Patent Application Publication
(10) Pub. No.: US 2011/0181679 A1
(43) Pub. Date: Jul. 28, 2011

(54) EXPOSURE DEVICE AND IMAGE FORMING APPARATUS

(75) Inventors: Yasuhiro ARAI, Kanagawa (JP); Hayato YOSHIKAWA, Kanagawa (JP); Masaki FUJISE, Kanagawa (JP); Kenji KOIZUMI, Kanagawa (JP)

(73) Assignee: FUJI XEROX CO., LTD., Tokyo (JP)

(21) Appl. No.: 12/909,105

(22) Filed: Oct. 21, 2010

(30) Foreign Application Priority Data
Jan. 27, 2010 (JP) 2010-015385

(51) Int. Cl. B41J 2/435

(52) U.S. Cl. 347/224

(57) ABSTRACT

An exposure device includes a light source, an image processing unit, and a light emitting control unit. In the light source, plural light emitting elements are arranged in main scanning and in sub-scanning directions. The image processing unit, based on image information relating to an image and processing information relating to a processing method of the image, executes image processing of converting into image information for exposure in a processing method corresponding to the processing information. The light emitting control unit controls the light emitting elements in accordance with the image information for exposure to emit light beams. The light emitting control unit controls the light emitting elements which are to emit the light beams based on a periodicity, in the sub-scanning direction, corresponding to the image processing executed in the image processing unit and a periodicity of an arrangement of the light emitting elements in the sub-scanning direction.

### CROSS-REFERENCE TO RELATED APPLICATIONS

This application is based on and claims priority under 35 USC 119 from Japanese Patent Application No. 2010-15385 filed on Jan. 27, 2010.

### BACKGROUND

### Technical Field

The invention relates to an exposure device and an image forming apparatus.

### SUMMARY

According to an aspect of the invention, an exposure device includes a light source, an image processing unit and a light emitting control unit. In the light source, a plurality of light emitting elements are arranged in a main scanning direction and in a sub-scanning direction. An image processing unit, based on image information relating to an image and processing information relating to a processing method of the image, executes image processing of converting the image information into image information for exposure in a processing method corresponding to the processing information. The light emitting control unit controls the light emitting elements in accordance with the image information for exposure to emit light beams. The light emitting control unit controls the light emitting elements which are to emit the light beams based on a periodicity, in the sub-scanning direction, corresponding to the image processing executed in the image processing unit and a periodicity of an arrangement of the light emitting elements in the sub-scanning direction.

### BRIEF DESCRIPTION OF THE DRAWINGS

Exemplary embodiments of the invention will be described in detail based on the following drawings, wherein:

FIG. 1 is an overall view of an image forming apparatus according to an exemplary embodiment 1 of the invention;

FIG. 2 is an enlarged view of main portions of the image forming apparatus according to the exemplary embodiment 1 of the invention;

FIG. 3 is an overall view of an exposure device according to the exemplary embodiment 1 of the invention;

FIGS. 4A and 4B are explanatory views of an arrangement of light emitting elements according to the exemplary embodiment 1 of the invention, FIG. 4A illustrates the arrangement of the light emitting elements in a light source, and FIG. 4B illustrates a state were the light emitting elements are arranged on a straight line in a sub-scanning direction with the light emitting elements being located in the same position in terms of a main scanning direction;

FIG. 5 illustrates main portions of a controller according to the exemplary embodiment 1 of the invention;

FIG. 6 illustrates main portions of a light emitting control unit of the controller;

FIGS. 7A and 7B illustrate a correspondence relation among selection information, light emitting elements and pixels, FIG. 7A illustrates a correspondence relation between the selection information and the light emitting elements, and FIG. 7B is a table showing a correspondence relation among the selection information, the light emitting elements and the pixels;

FIGS. 8A to 8C illustrate a structure of a VCSEL of a comparative example, FIG. 8A illustrates is an overall view, FIG. 8B illustrates a state where the VCSEL of FIG. 8A is inclined, and FIG. 8C illustrates a state where laser diodes are arranged on a straight line in the sub-scanning direction with the laser diodes being located in the same position in terms of the main scanning direction; and

FIGS. 9A to 9C illustrate exposure modes, FIG. 9A shows an arrangement of laser diodes, FIG. 9B is an explanatory view for a double exposure and FIG. 9C is an explanatory view for an adjacent exposure.

### DETAILED DESCRIPTION

In the followings, exemplary embodiments of the invention will be described with reference to the accompanying drawings. However, it should be noted that the invention is not limited to the following exemplary embodiments.

Additionally, in order to facilitate understanding of the following explanation, in the drawings, a front-rear direction is referred to as an X-axis direction, a left-right direction is referred to as a Y-axis direction and an upper-lower direction is referred to as a Z-axis direction, and directions or sides indicated by arrows X, -X, Y, -Y, Z and -Z are referred to as front, rear, right, left, upper and lower or front, rear, right, left, upper and lower sides, respectively.

In the drawings, “⊙” indicates an arrow heading from the rear side of a sheet to the front side thereof, and “ [symbol] ” indicates an arrow heading from the front side of a sheet to the rear side thereof. In the following descriptions, other members except members necessary for explanations may be appropriately omitted so as to facilitate understanding of the descriptions.

### Exemplary Embodiment 1

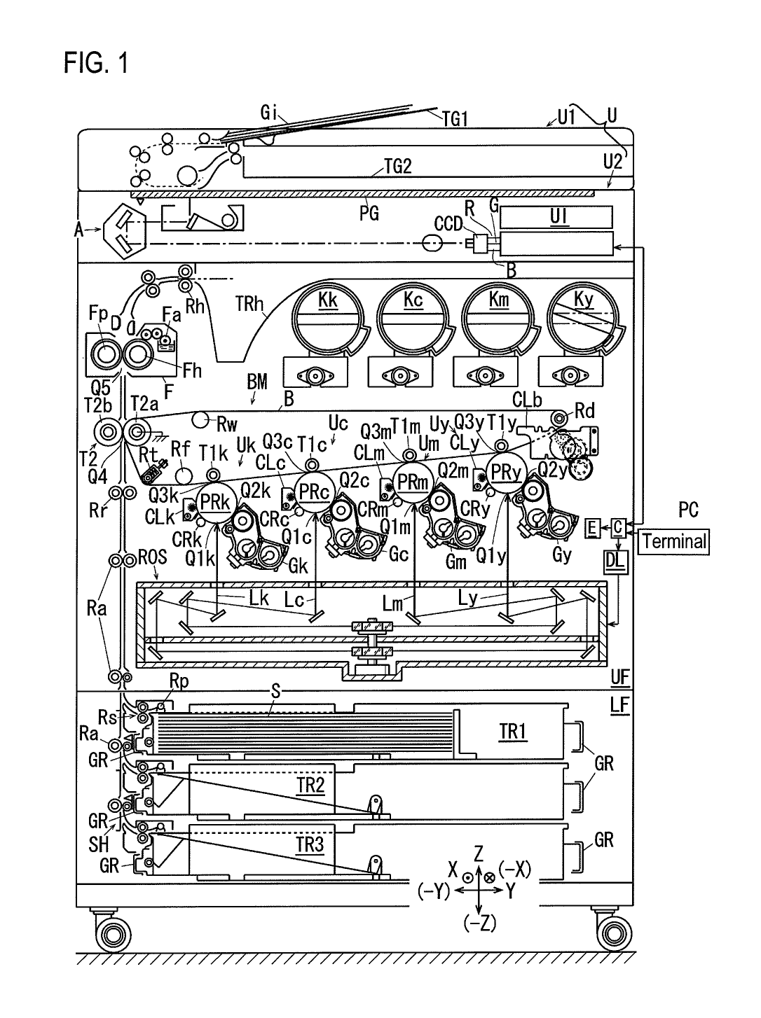

FIG. 1 illustrates an entire image forming apparatus according to an exemplary embodiment 1 of the invention.

In FIG. 1, a copier U which is an example of an image forming apparatus has an automatic document feeder U1 and an apparatus main body U2 that supports the automatic document feeder U1 and a document-reading transparent surface (PG: platen glass) on an upper end thereof.

The automatic document feeder U1 has a document feeder section TG1 in which plural documents Gi to be copied is stored and stacked, and a document discharge section TG2 to which a document Gi fed from the document feeder section TG1 and having passed through a document reading position on the document reading surface PG is discharged.

The apparatus main body U2 has an operation section UI with which a user inputs an operation command signal and the like such as a command to start an image forming operation, an exposure optical system A and the like.

A reflective light from a document conveyed to the document reading surface PG by the automatic document feeder U1 or a document manually put on the document reading surface PG is converted into electric signals of red (R), green (G) and blue (B) by a solid imaging device CCD through the exposure optical system A.

The electric signals of the RGB input from the solid imaging device CCD are converted into image information of an object to be exposed, i.e., black (K), yellow (Y), magenta (M) and cyan (C) and then temporarily stored in a controller C. At a preset time, the image information is processed into image information for exposure, which is then output to a latent image forming circuit DL.

In addition, when a document image is a single-color image, so-called monochrome, image information of black (K) is only input to the latent image forming circuit DL.

Further, when image information of an object to be exposed is transmitted from a terminal PC such as personal computer, which is an example of an image information transmission apparatus, the image information is converted into the image information for exposure, i.e., image information for forming a latent image in the controller C, which is then output to the latent image forming circuit DL.

The latent image forming circuit DL has latent image forming circuits (not shown) for each color (Y, M, C, K) and outputs a latent-image-forming-device driving signal corresponding to the input image information to a latent image forming device ROS, which is an example of the exposure device, at a preset time.

Visible image forming devices Uy, Um, Uc, Uk, which are arranged above the latent image forming device ROS, are devices that form toner images which are examples of visible images of yellow (Y), magenta (M), cyan (C) and black (K). Latent image writing light beams Ly, Lm, Lc, Lk are emitted from the latent image forming device ROS. The latent image writing light beams Ly, Lm, Lc, Lk are respectively incident on rotating photosensitive members PRy, PRm, PRc, PRk, which are examples of image carriers.

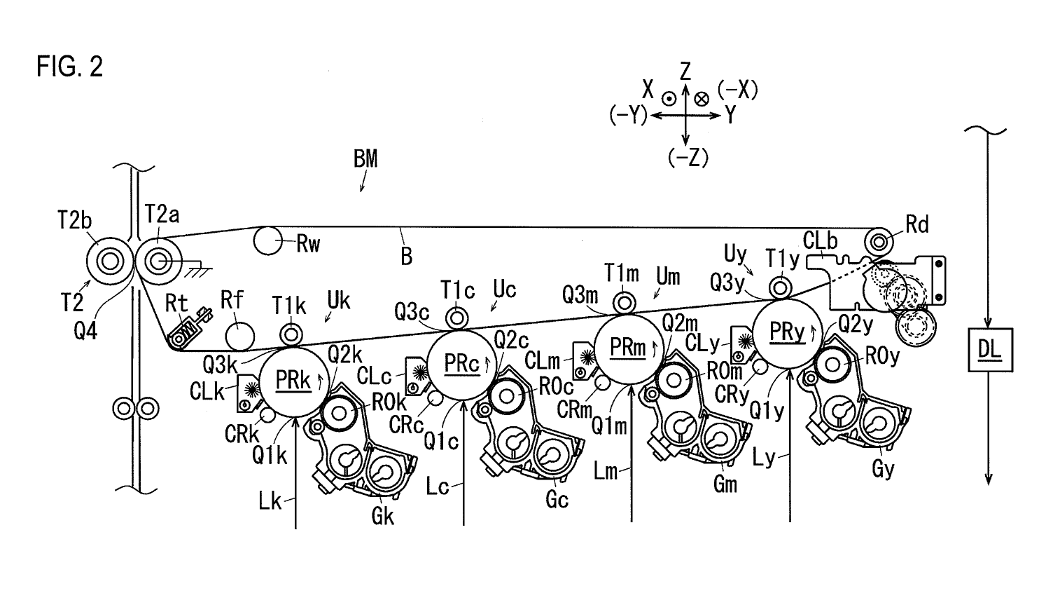

The Y-color visible image forming device Uy has the photosensitive member PRy, a charger Cry, a developing device Gy and an image-carrier cleaner CLy, and all the visible image forming devices Um, Uc, Uk have the same structures as that of the Y-color visible image forming device Uy. FIG. 2 is an enlarged view of main portions of the image forming apparatus according to the exemplary embodiment 1 of the invention.

In FIGS. 1 and 2, after the respective photosensitive members PRy, PRm, PRc, PRk are charged by the respective chargers CRy, CRm, CRc, CRk, latent images are formed on surfaces of the photosensitive members PRy, PRm, PRc, PRk at image writing positions Q1y, Q1m, Q1c, Q1k by the latent image writing light beams Ly to Lk. The latent images on the surfaces of the photosensitive members PRy, PRm, PRc, PRk are developed into toner images, which are example of visible images, at developing regions Q2y, Q2m, Q2c, Q2k by developer carried on developing rolls R0y, R0m, R0c, R0k, which are examples of developer carriers of developing devices Gy, Gm, Gc, Gk.

The developed toner images are conveyed to primary transfer regions Q3y, Q3m, Q3c, Q3k where the photosensitive members PRy, PRm, PRc, PRk are in contact with an intermediate transfer belt B which is an example of an intermediate transfer member. Primary transfer units T1y, T1m, T1c, T1k, which are arranged on a backside of the intermediate transfer belt B in the primary transfer regions Q3y, Q3m, Q3c, Q3k, are applied at a preset time with a primary transfer voltage, which has an opposite polarity to a charged polarity of toner, from a power supply circuit E that is controlled by the controller C.

The toner images on the respective photosensitive members PRy to PRk are primarily transferred onto the intermediate transfer belt B by the primary transfer units T1y, T1m, T1c, T1k. Residuals matters and adhering matters on the surfaces of the photosensitive members PRy, PRm, PRc, PRk after the primary transfer are cleaned by photosensitive-member cleaners CLy, CLm, CLc, CLk. The cleaned surfaces of the photosensitive members PRy, PRm, PRc, PRk are again charged by the chargers CRy, CRm, CRc, CRk.

A belt module BM, which is an example of an intermediate transfer device, is arranged above the photosensitive members PRy, PRm, PRc, PRk. The belt module BM has the intermediate transfer belt B, a belt driving roll Rd which is an example of an intermediate-transfer-member driving member, a tension roll Rt which is an example of a tension applying member, a walking roll Rw which is an example of a meandering prevention member, an idler roll Rf which is an example of a driven member, a backup roll T2a which is an example of a secondary-transfer opposite member, and the primary transfer units T1y, T1m, T1c, T1k. The intermediate transfer belt B is rotatably supported by the respective rolls Rd, Rt, Rw, Rf, T2a.

A secondary transfer roll T2b, which is an example of a secondary transfer member, is arranged to be opposite to a surface of the intermediate transfer belt B being in contact with the backup roll T2a. The backup roll T2a and the secondary transfer roll T2b constitute a secondary transfer unit T2. In addition, a secondary transfer region Q4 is formed in a region where the secondary transfer roll T2b faces the intermediate transfer belt B.

The toner images of a single color transferred or multi colors sequentially overlapped and transferred at the primary transfer regions Q3y, Q3m, Q3c, Q3k on the intermediate transfer belt B by the primary transfer units T1y, T1m, T1c, T1k are conveyed to the secondary transfer region Q4.

The primary transfer units T1y to T1k, the intermediate transfer belt B and the secondary transfer unit T2 constitute the transfer device (T1+T2+B) of the exemplary embodiment 1, which transfers the images formed on the photosensitive members PRy to PRk to a medium.

A pair of left and right guide rails GR, which is an example of a guide member, is provided in three stages below the visible image forming devices Uy to Uk. Sheet feeding trays TR1 to TR3, which is an example of a sheet feeding section, are supported by the guide rails GR so that they can advance and retreat in the front-and-rear direction. Recording sheets S, which are an example of media stored in the sheet feeding trays TR1 to TR3, are taken out by a pickup roll Rp, which is an example of a medium taking-out member, and are separated one by one by a separation roll Rs, which is an example of a medium separation member. Then, the recording sheet S is conveyed along a sheet conveyance path SH, which is an example of a medium conveyance path, by plural delivery rolls Ra, which are an example of a medium conveyance member, and is sent to a register roll Rr, which is an example of a conveyance time regulating member arranged on an upstream of the secondary transfer region Q4 in a sheet conveyance direction. The sheet conveyance path SH, the sheet delivery roll Ra and the register roll Rr constitute the sheet delivery device (SH+Ra+Rr).

The register roll Rr conveys the recording sheet S to the secondary transfer region Q4 in synchronization with a time when the toner images formed on the intermediate transfer belt B are conveyed to the secondary transfer region Q4. When the recording medium S passes through the secondary transfer region Q4, the backup roll T2a is earthed, and the secondary transfer unit T2b is applied with a secondary transfer voltage having a polarity opposite to the charged polarity of toner from the power supply circuit E, which is controlled by the controller C. At this time, the toner images on the intermediate transfer belt B are transferred onto the recording sheet S by the secondary transfer unit T2.

The intermediate transfer belt B after the secondary transfer is cleaned by a belt cleaner CLb, which is an example of an intermediate-transfer-member cleaner.

The recording sheet S on which the toner images have been secondarily transferred is conveyed to a fixing region Q5 where a heating roll Fh, which is an example of a fixing member for heating of a fixing device F, and a pressing roll Fp, which is an example of a fixing member for pressing, are in contact with each other and is heated and fixed when it passes through the fixing region Q5. The recording sheet S that has been heated and fixed is discharged from a discharge roller Rh, which is an example of a medium discharge member, to a sheet discharge tray TRh, which is an example of a medium discharge section.

In addition, a surface of the heating roll Fh is applied with a release agent for well releasing the recording medium S from the heating roll Fh by a release-agent applying device Fa.

Developer cartridges Ky, Km, Kc, Kk, which are examples of developer accommodating containers accommodating respective developers of yellow (Y), magenta (M), cyan (C) and black (K), are arranged above the belt module BM. The developers accommodated in the respective developer cartridges Ky, Km, Kc, Kk are supplied to the respective developing devices Gy, Gm, Gc, Gk as the developers of the developing devices Gy, Gm, Gc, Gk are consumed. Further, in the exemplary embodiment 1, the developers accommodated in the developing devices Gy, Gm, Gc, Gk are two-components developers including magnetic carrier and toner having external additive added thereto. Toner is supplied from the developer cartridges Ky to Kk to the developing devices Gy to Gk.

### Description of Exposure Device

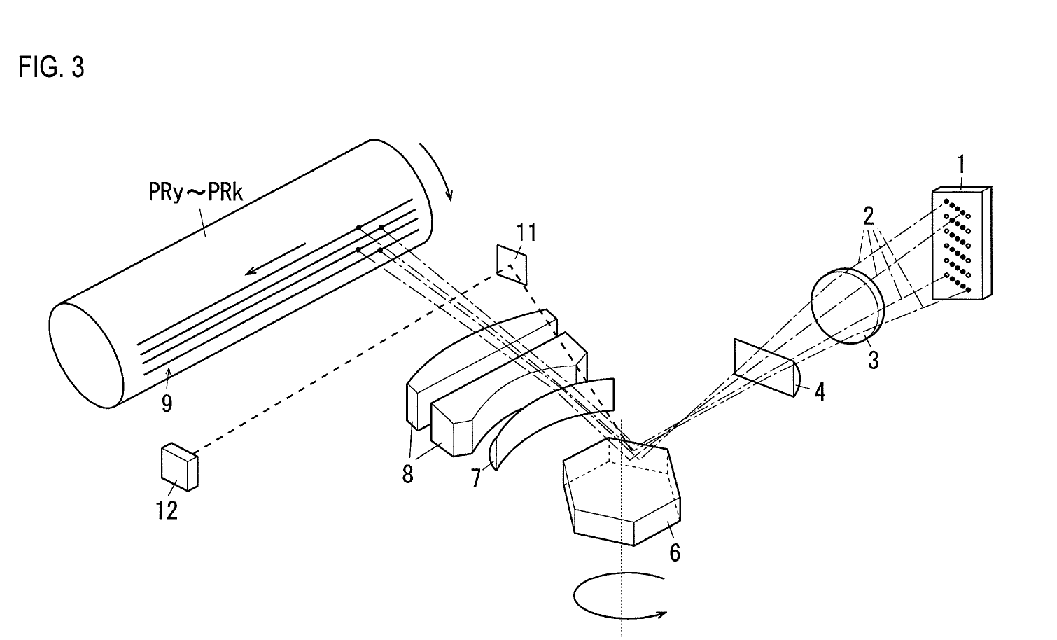

FIG. 3 is an overall view of the exposure device according to the exemplary embodiment 1 of the invention.

In FIG. 3, the latent image forming device ROS according to the exemplary embodiment 1 of the invention has a laser array 1, which is an example of a light source, for each color of yellow (Y), magenta (M), cyan (C) and black (K), in which plural light emitting elements is arranged in a main scanning direction and a sub-scanning direction of the photosensitive members PRy to PRk. As the laser array 1 in which the light emitting elements are arranged two-dimensionally, e.g., in the main scanning direction and the sub-scanning direction, VCSEL (Vertical Cavity Surface Emitting Laser) may be adopted. However, the invention is not limited thereto. For example, an arbitrary structure may be adopted so long as light emitting elements are arranged two-dimensionally. The laser light beams emitted from the laser array 1 are applied to a rotary polygon mirror 6, which rotates at the preset number of revolutions, so-called polygon mirror through a collimator lens 3 and a cylindrical mirror 4, which are examples of a collimating optical system.

The laser light beams 2 reflected on the polygon mirror 6 are applied to the surfaces of the photosensitive members PRy to PRk through a toroidal lens 7, scanning lenses 8 (so-called fθ lenses 8) and a reflective mirror (not shown), which are an example of an illumination optical system. Accordingly, in the laser array 1 of the exemplary embodiment 1, when the scanning is performed in the main scanning direction with one surface of the polygon mirror 6, plural scanning line groups 9 is formed which are spaced in the sub-scanning direction.

In addition, the laser light beams 2 are incident on a light detector 12 through a reflective mirror 11 at a position spaced in the main scanning direction of the photosensitive members PRy to PRk just before or just after the scanning of the scanning line groups 9, so that a shift to a next scanning is detected. In other words, a so-called SOS (Start of Scan) signal is output.

### Description of Arrangement of Laser Diodes

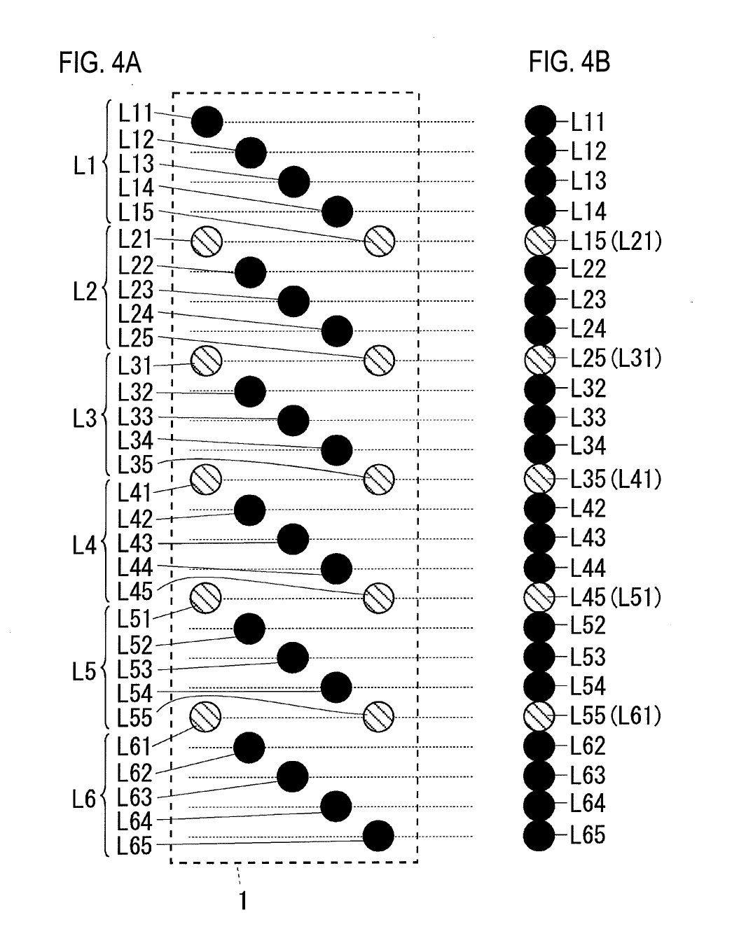

FIG. 4 illustrates an arrangement of light emitting elements according to the exemplary embodiment 1 of the invention. FIG. 4A illustrates the arrangement of the light emitting elements in the light source. FIG. 4B shows a state were the light emitting elements are arranged on a straight line in the sub-scanning direction with the light emitting elements being located in the same position in terms of the main scanning direction.

The laser array 1 of the exemplary embodiment 1 shown in FIG. 4 has laser diodes L11 to L65 which are an example of the light emitting elements. The laser diodes L11 to L65 have a first element group L1 including five laser diodes L11, L12, L13, L14, L15 which are arranged at intervals in the main scanning direction and the sub-scanning direction. At a position shifted in the sub-scanning direction with respect to the first element group L1, a second element group L2 is arranged which includes five laser diodes L21, L22, L23, L24, L25 that are sequentially arranged at intervals in the main scanning direction and the sub-scanning direction in a similar manner to the first element group L1. Likewise, a third element group L3 including five laser diodes L31, L32, L33, L34, L35, a fourth element group L4 including five laser diodes L41, L42, L43, L44, L45, a fifth element group L5 including five laser diodes L51, L52, L53, L54, L55 and a sixth element group L6 including five laser diodes L61, L62, L63, L64, L65 are arranged.

Accordingly, the laser array 1 of the exemplary embodiment 1 has the thirty (five laser diodes by six groups) laser diodes L11 to L65.

In adjacent element groups of the respective element groups L1 to L6, (i) the laser diode (L15, L25, L35, L45, L55), which is arranged at an end of one of the adjacent element groups (L1 to L5) on one side in the sub-scanning direction, and (ii) the laser diode (L21, L31, L41, L51, L61), which is arranged at an end of the other element group (L2 to L6) on the other side in the sub-scanning direction, are arranged at the same position in terms of the sub-scanning direction.

Thus, in the exemplary embodiment 1, although the thirty laser diodes L11 to L65 are provided, twenty five laser diodes are arranged in the sub-scanning direction with the overlapped laser diodes being taken into consideration. Therefore, when the laser diodes L11 to L65 are made to emit light while a timing in the main scanning direction is adjusted, twenty five pixels, so-called twenty five dots are written by one irradiation and, twenty-five scanning line groups 9 are exposed by one scanning.

### Description of Controller C

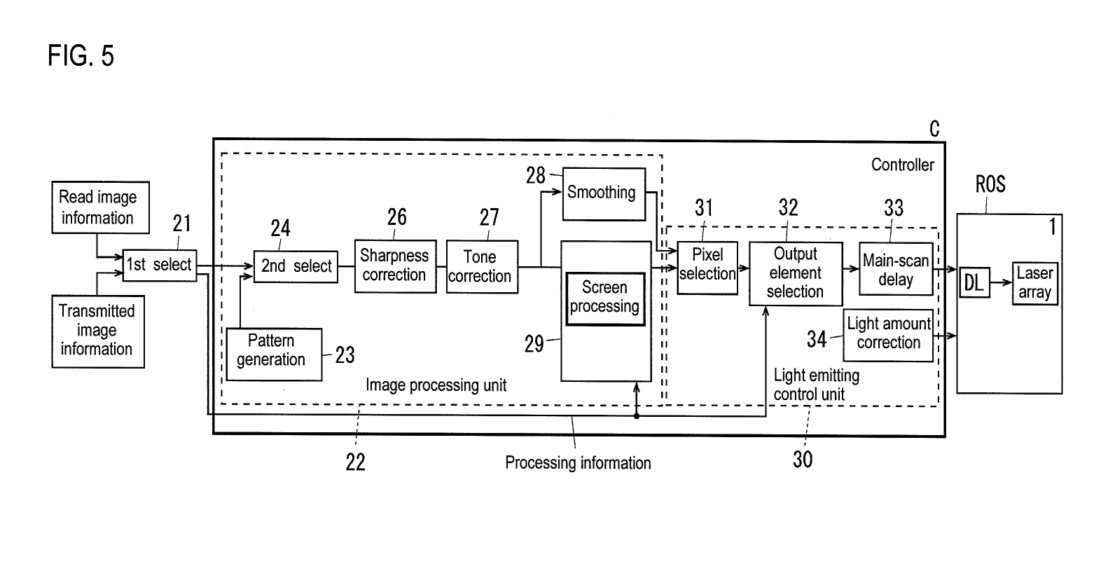

FIG. 5 illustrates main portions of the controller C according to the exemplary embodiment 1 of the invention.

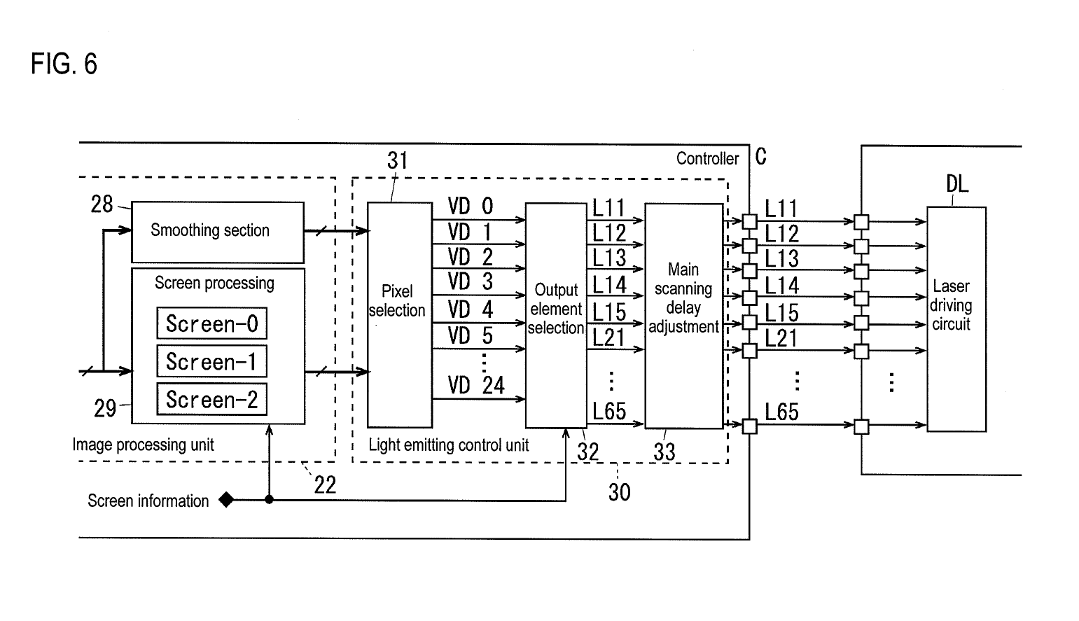

FIG. 6 illustrates main portions of a light emitting control unit 30 of the controller C.

In FIGS. 5 and 6, the controller C is configured by a small-sized information processing device, so-called micro computer. The micro computer includes an input/output interface I/O, which inputs/outputs signals to/from an outside and adjusts an input/output signal level, a read only memory (ROM) storing programs and information for performing necessary processes, a random access memory (RAM) which temporarily stores necessary data, a central processing unit (CPU), which executes a process in accordance with the program stored in the ROM, and an oscillator. The controller C can execute the programs stored in the ROM to implement a variety of functions.

An first image information selection section 21 selects and inputs the image information read by the exposure optical system A or the image information transmitted from the terminal PC in accordance with an input order, to an image processing unit 22 of the controller C of the exemplary embodiment 1 shown in FIG. 5. At this time, in the exemplary embodiment 1, the image information read by the exposure optical system A includes processing information such as a resolution set up by the operation section UI, information indicating either single color or multi colors and information indicating characters or a photograph, for example. Likewise, the image information transmitted from the terminal PC also includes the processing information such as a resolution, information indicating either a single color or multi colors, and information indicating either characters or a photograph. Examples of the processing information include the resolution, the information indicating either a single color or multi colors, and the information indicating either characters or a photograph. However, the invention is not limited thereto. For example, image forming speed, so-called process speed may be used.

The image processing unit 22 has a pattern generation section 23 that is an example of an adjusted image generation section and that stores and generates adjusted image information for adjusting shading of an image to be printed, so-called calibration pattern image. When an instruction to execute image adjustment is input, the pattern generation section 23 outputs information of the calibration pattern image. The image information input from the first image information selection section 21 and the information output from the pattern generation section 23 are input to a second image information selection section 24, and are selected in an input order and then output.

The image information output from the second image information selection section 24 is subject to a sharpness process in a sharpness correction section 26 that is an example of a contour emphasis section, and is then subject to a tone correction process in a tone correction section 27. The sharpness process and the tone correction are well known, and any process can be adopted for the processes. Thus, the detailed descriptions thereon are omitted here.

In FIGS. 5 and 6, the image information for which the tone correction has been performed is subject to a process for smoothing a contour, i.e., an edge smoothing process in a smoothing section 28 that is an example of a contour smoothing section. The edge smoothing process is also well known, and any process can be adopted for the process. Thus, the detailed description thereon is omitted here.

Further, the image information for which the tone correction has been performed is subject to a screen process of creating a tone of a color by the number or density of pixels in accordance with the input image information, in a screen processing section 29 that is an example of a tone image generation section. In the screen processing section 29 of the exemplary embodiment 1, based on the processing information, an arrangement angle, so-called screen angle at which halftone dots each of which a group of pixels are arranged, and the number of screen lines which is a density of pixels, are set, and image information for exposure is generated in accordance with the set screen angle and the number of screen lines. For instance, when the input image information is black (K), the screen angle is set to be 45°, and when the input image information is yellow (Y), magenta (M) and cyan (C), the screen angle is set to be 20°, 70° and 160°, respectively. Further, for example, for a photograph image or a low resolution setting, a tone property is preferential, so that the number of screen lines is set to be 150 per inch. For a character image or a high resolution setting, a sharpness property is preferential, so that the number of screen lines is set to be 200 per inch.

In the meantime, the respective settings, the number of screen lines and the screen angle are not limited to the above exemplified values and may be arbitrarily changed depending on designs. For example, types of screen may be used in addition to the number of screen lines and the screen angle. The types of screen may include a dot type or line type regarding the method of growing the halftones or may be selected and set by a so-called dither method or an error diffusion method.

Furthermore, it is possible to select and set the number of screen lines, the screen angle and the screen type in accordance with the set operation modes of the copier U such as a mixed setting of a photograph and characters, speed preference/image-quality preference and multi colors/single color.

Additionally, in the process performed in the screen processing section 29, the information such as the number of screen lines and the screen angle is stored in a storage medium, a so-called memory, which is not shown.

In the exemplary embodiment 1, when the screen angle and/or the number of screen lines is set, selection information is set. As the selection information, “0”, “1” and “2” are set. The selection information will be described in detail later.

The image information output from the smoothing section 28 and the image information output from the screen processing section 29 are input to a pixel selection section 31 of the light emitting control unit 30 which selects pixels to emit light. In the exemplary embodiment 1, depending on the image information input to the pixel selection section 31, signals VD0 to VD24 are output which controls whether or not to emit light for each of the 25 pixels in the sub-scanning direction which can be written at a time.

The signals VD0 to VD24 output from the pixel selection section 31 are input to an output element selection section 32, and the output element selection section 32 selects which laser diodes of the 30 laser diodes L11 to L65 is made to correspond to which pixels, i.e., selects a light emitting pattern.

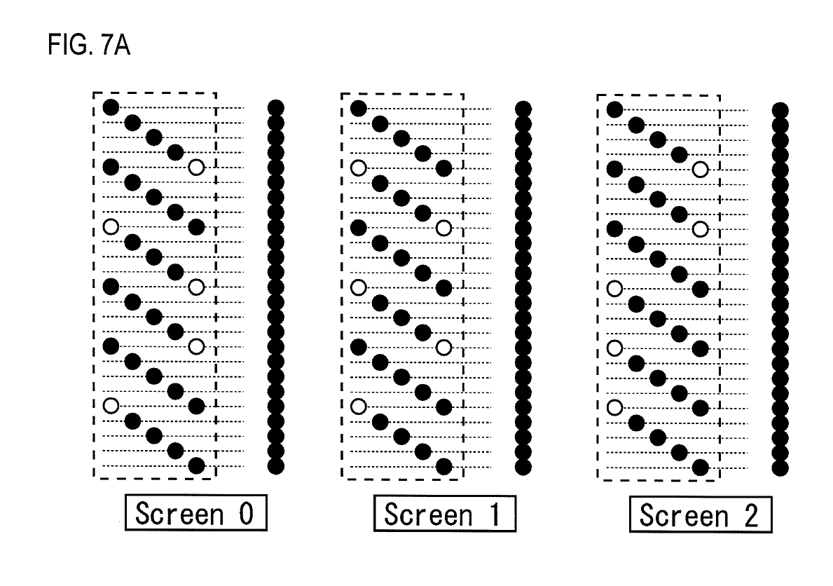

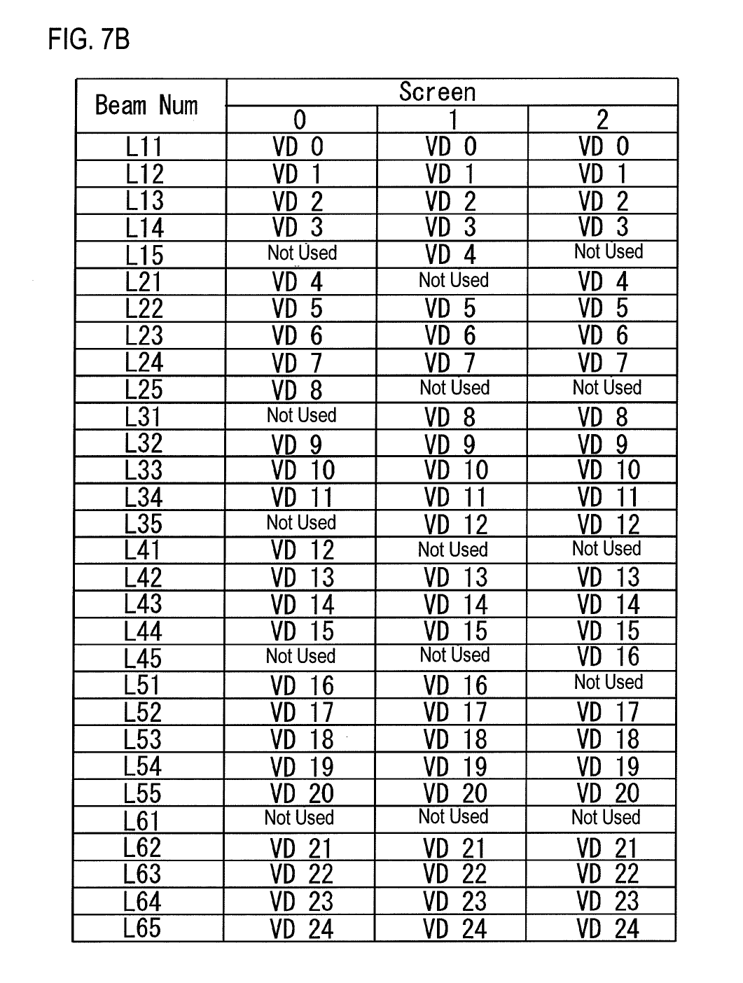

FIGS. 7A and 7B illustrate a correspondence relation among the selection information, the light emitting elements and the pixels. FIG. 7A illustrates a correspondence relation between the selection information and the light emitting elements. FIG. 7B is a table showing a correspondence relation among the selection information, the light emitting elements and the pixels.

In FIG. 7, in the output element selection section 32 of the exemplary embodiment 1, the laser diodes L11 to L65, which are controlled by the respective control signals VD0 to VD24 are set based on the selection information from the screen processing section 29. The respective control signals VD0 to VD24 are assigned to control signals for the selected laser diodes L11 to L65. For example, when the selection information is “0,” of the laser diodes L15 and L21, which are overlapped in the sub-scanning direction, the laser diode L21 is used, but the laser diode L15 is not used, and the laser diode L25 of the laser diodes L25 and L31, the laser diode L41 of the laser diodes L35 and L41, the laser diode L51 of the laser diodes L45 and L51, and the laser diode L55 of the laser diodes L55 and L61 are used, respectively. Accordingly, the control signals VD0 to VD24 of the pixels are sequentially assigned to the twenty five laser diodes to be used. When the selection information is “1” and “2,” five laser diodes which are not used and twenty laser diodes to be used are set and the control signals VD0 to VD24 are assigned, based on the correspondence relation which is preset as shown in FIG. 7B.

In FIG. 7A, in the exemplary embodiment 1, when the selection information is “0,” the numbers of elements to emit light in the first element group L1 to the sixth element group L6 is four, five, three, four, five and four, respectively. Likewise, when the selection information is “1,” the numbers of elements to emit light is five, three, five, three, five and four, respectively. When the selection information is “2,” the numbers of elements to emit light is four, four, five, four, four and four, respectively. In other words, the way in which the number of laser diodes to emit light appears repeatedly in the element groups L1 to L6, i.e., a periodicity is different depending on the selection information. In the exemplary embodiment 1, the periodicity is set based on a result which is previously confirmed by a test so that a periodicity of the arrangement of the laser array 1 in the sub-scanning direction and a periodicity relating to the screen angle or number of screen lines are different.

In FIGS. 5 and 6, the control signals of the respective laser diodes L11 to L65 output from the output element selection section 32 are input to a main scanning delay adjusting section 33, so that a delay process is carried out which shifts a timing at which the laser diodes emit light when the scanning is performed in the main scanning direction, in accordance with the positions of the laser diodes L11 to L65 in the main scanning direction. The signals for which the delay process has been performed in the main scanning delay adjusting section 33 are output to the laser driving circuit DL of the latent image forming device ROS. Additionally, information for correcting and setting amounts of laser light beams from the respective laser diodes L11 to L65 is also input to the laser driving circuit DL from a light amount correction section 34. Control signals are output from the laser driving circuit DL to the laser array 1 at a preset timing, so that the respective laser diodes L11 to L65 emit light beams, and a latent image is thus written.

### Operation of Exemplary Embodiment 1

In the copier U having the above configuration of the exemplary embodiment 1, when the image information read by the exposure optical system A or transmitted from the terminal PC is subject to image processing to generate image information for exposure in the latent image forming device ROS, an appropriate screen angle or number of screen lines is selected in accordance with the processing information, and the image processing is performed. Then, the laser diodes L11 to L65 to be used are selected in accordance with the selected screen angle or number of screen lines, the laser diodes emit light beams, and a latent image is thus formed.

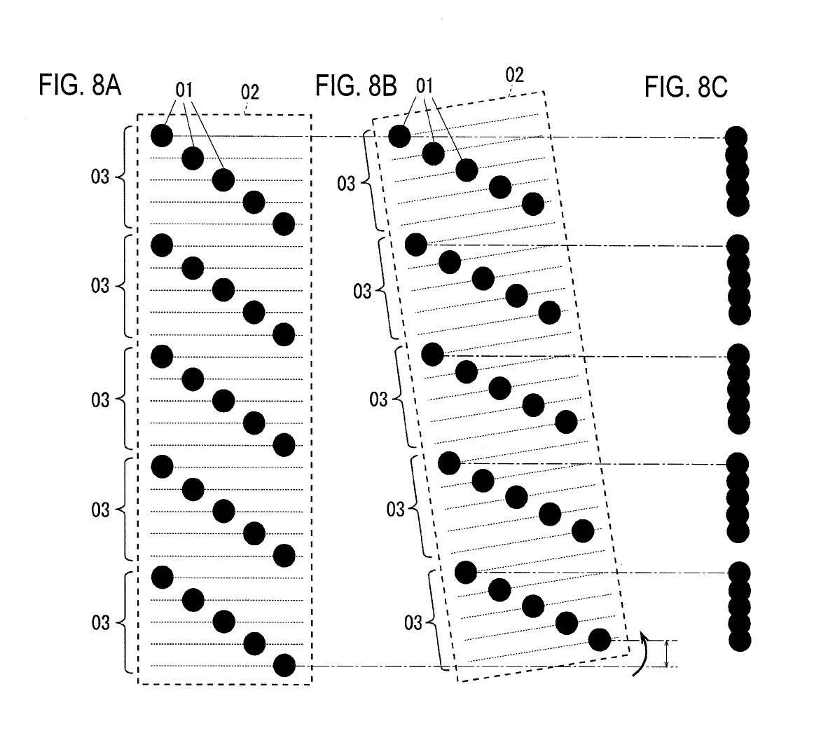

FIGS. 8A to 8C illustrate a configuration of a VCSEL of a comparative example. FIG. 8A illustrates an overall view of the VCSEL of the comparative example. FIG. 8B illustrates a state where the VCSEL of FIG. 8A is inclined. FIG. 8C illustrates a state where laser diodes are arranged on a straight line in the sub-scanning direction with the laser diodes being located in the same position in terms of a main scanning direction of FIG. 8B.

In FIG. 8, like the laser array 1 of the exemplary embodiment 1, in a laser array 02 in which twenty five light emitting elements 01 are arranged in the sub-scanning direction, five element groups 03 each of which has five light emitting elements 01 are arranged, and the light emitting elements 01 are not overlapped in the sub-scanning direction. When the laser array 02 is attached to a main body of an image forming apparatus, the laser array may be inclined due to an attachment error. At this time, intervals of the pixels to be written in the laser array 02 in the sub-scanning direction become wider between the element groups 03, i.e., every five pixels. Thus, in the arrangement of the laser array 02, a gap is formed in a line in the sub-scanning direction every five pixels. As a result, a width having low density, i.e., an image defect occurs as a whole. When the period of five pixels coincides with or becomes integer multiples of the periodicity of the screen angle or number of screen lines, the image defect is emphasized every five pixels. In addition, even when the period of five pixels does not coincide with the periodicity of the image processing such as screen angle, if it is assumed that the periodicity of the image processing is T, a periodic image defect occurs in the sub-scanning direction every 5×T which is the least common multiple.

To the contrary, in the exemplary embodiment 1, the periodicity of the arrangement of the laser array 1 is set to be different based on the selection information corresponding to the periodicity of the image processing. An image defect of twenty five or less pixels in the sub-scanning direction, which are exposed by the laser diodes L11 to L65 arranged in the laser array 1, is reduced. Also, the numbers of the laser diodes L11 to L65 to emit light beams in the respective element groups L1 to L6, which are set in the correspondence in FIG. 7B, are set to be different in accordance with the selection information. Thus, there is no periodicity of the five pixels, like the laser array 02 of the comparative example. In the exemplary embodiment 1, the periodicity in the sub-scanning direction is twenty five pixels which are written in one scanning. As a result, a period during which a periodic image defect occurs in the sub-scanning direction becomes 25×T. Therefore, as compared with the comparative example, the period and frequency at which an image defect occurs is reduced, and an image defect is thus unnoticeable as a whole.

### Modified Exemplary Embodiments

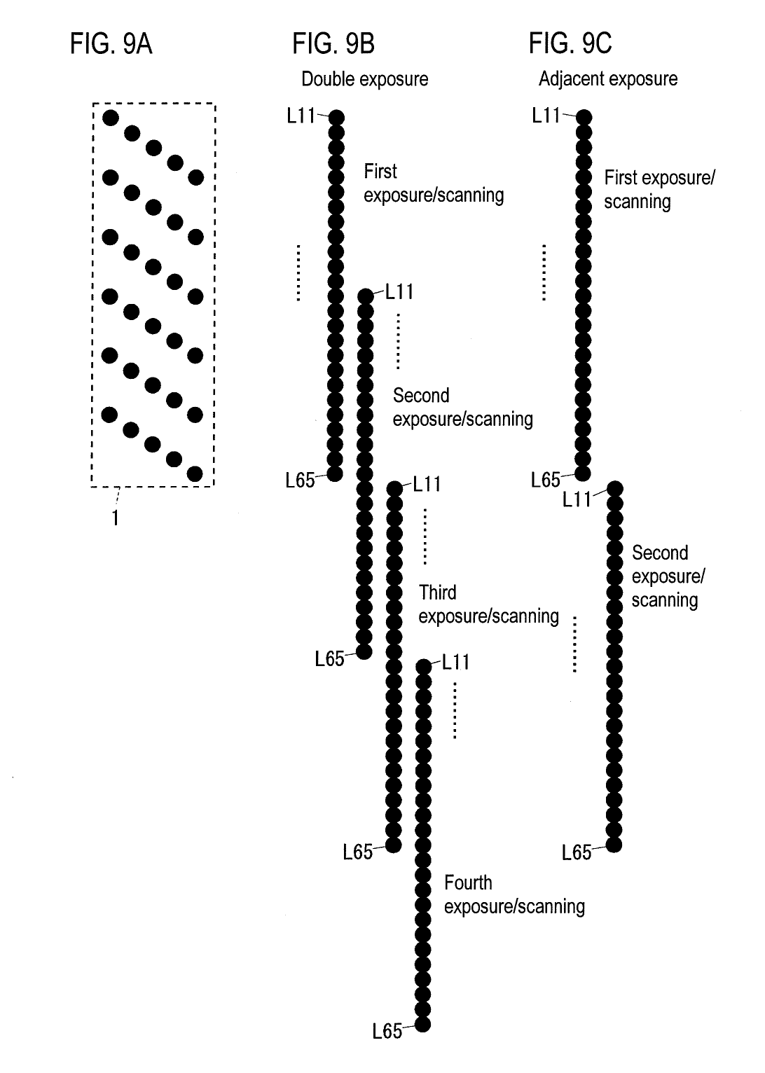

The Exemplary embodiments of the invention have been specifically described above. However, it should be noted that the invention is not limited thereto and can be variously changed without departing from the scope of the invention defined in the claims. Modified exemplary embodiments H01 to H09 of the invention will be described below.
(H01) In the above exemplary embodiment, the copier U has been exemplified as the image forming apparatus. However, the invention is not limited thereto. For example, the invention can be applied to a printer, a FAX or a multi-function device having some or all of the functions thereof.
(H02) In the above exemplary embodiment, the copier U using the developers of four colors has been exemplified. However, the invention is not limited thereto. For example, the invention may be applied to an image forming apparatus of a single color or an image forming apparatus of multi colors such as five colors or more or three colors or less.
(H03) In the above exemplary embodiment, the number of the laser diodes L11 to L65 or the number of the element groups L1 to L6 of the laser array 1 may be arbitrarily changed in accordance with design or specification. Likewise, the number of laser diodes included in the respective element groups L1 to L6 may be arbitrarily changed. Meanwhile, in the above exemplary embodiment, the numbers of light emitting elements included in the respective element groups L1 to L6 are unified to be five. However, the invention is not limited thereto. For example, the numbers of light emitting elements included in the respective element group may be different from each other.
(H04) In the above exemplary embodiment, the specific values of the screen angle and the specific number of screen lines are exemplified. However, the invention is not limited thereto. The screen angle and the number of screen lines may be arbitrarily changed depending on designs or uses.
(H05) In the above exemplary embodiment, the number of the selection patterns of the laser diodes L11 to L65 is three, that is, the light emitting patterns of 0, 1 and 2. However, the invention is not limited thereto. For example, different patterns may be used. Also, two light emitting patterns or four or more light emitting patterns may be used. In addition, in the above exemplary embodiment, the light emitting pattern is common in the laser array 1 of yellow (Y), magenta (M), cyan (C) and black (K). However, the invention is not limited thereto. For example, it may be possible that the data as shown in FIG. 7 is provided for each color, and different light emitting patterns may be used for the respective colors.
(H06) In the above exemplary embodiment, the respective sections included in the image processing unit 22 and the light emitting control unit 30 are not limited to those of the exemplary embodiment. For example, some processing may be omitted or another processing may be added.
(H07) In the above exemplary embodiment, twenty five laser diodes of the laser diodes L11 to L65 emit light beams depending on the screen selection information. However, the number of laser diodes L11 to L65 to emit light beams may be changed. For instance, in accordance with the setting of an image forming speed, so-called process speed, twenty five laser diodes may emit light beams during a high speed operation, and twenty laser diodes may emit light beams during a low speed operation. Further, it may be possible that twenty five laser diodes emit light beams in performing a multi-color printing, and that twenty laser diodes emit light beams in performing a single-color printing.
(H08) In the above exemplary embodiment, based on the processing information such as a resolution, information indicating either a single color or multi colors and information indicating either characters or a photograph, the light emitting pattern is switched. In other words, the light emitting pattern is switched every one image forming operation, so-called every job. However, the invention is not limited thereto. For example, the light emitting pattern may be switched based on the processing information in page units. Alternatively, when a “document region” and a “photograph region” are mixed in an image of one page, the light emitting pattern may be switched every scanning, not in page units.
FIGS. 9A to 9C illustrate exposure modes. FIG. 9A shows an arrangement of laser diodes. FIG. 9B illustrates a double exposure. FIG. 9C illustrates an adjacent exposure.
(H09) In the above exemplary embodiment, as shown in FIG. 9C, with respect to first exposure and scanning, a next exposure and scanning is performed so that one end of the scanning line of the first exposure in the sub-scanning direction is adjacent, in the sub-scanning direction, to another end of the scanning line of the second exposure in the sub-scanning direction. However, the invention is not limited thereto. For example, as shown in FIG. 9B, it may be possible that the first exposure and the second exposure are partially overlapped in the sub-scanning direction, and the double exposure is thus executed in the overlapped part. Accordingly, for instance, in accordance with the single-color/multi-color setting, the double exposure of FIG. 9B in which periodic unevenness every one scanning and density unevenness due to variation of scanning positions are inconspicuous, may be adopted in executing a multi-color printing so that an image quality defect is hard to occur. In executing a single color printing, the adjacent exposure of FIG. 9C which can promptly cope with high speed printing may be adopted to increase the productivity.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An exposure device comprising:
a light source in which a plurality of light emitting elements are arranged in a main scanning direction and in a sub-scanning direction;
an image processing unit that, based on image information relating to an image and processing information relating to a processing method of the image, executes image processing of converting the image information into image information for exposure in a processing method corresponding to the processing information; and
a light emitting control unit that controls the light emitting elements in accordance with the image information for exposure to emit light beams, wherein
the light emitting control unit controls the light emitting elements which are to emit the light beams based on a periodicity, in the sub-scanning direction, corresponding to the image processing executed in the image processing unit and a periodicity of an arrangement of the light emitting elements in the sub-scanning direction.

2. The exposure device according to claim 1, wherein
at least two of the light emitting elements are arranged at the same position in terms of the sub-scanning direction, and
based on the periodicity, in the sub-scanning direction, corresponding to the image processing and the periodicity of the arrangement of the light emitting elements in the sub-scanning direction, the light emitting control unit selects one of the at least two light emitting elements, which are arranged at the same position in terms of the sub-scanning direction, and causes the selected light emitting element to emit a light beam.

3. The exposure device according to claim 1, wherein
the light source includes element groups each having a plurality of light emitting elements which are arranged at intervals in the main scanning direction and in the sub-scanning direction,
the element groups are arranged in the sub-scanning direction, and
in the element groups adjacent to each other, a light emitting element which is arranged at an end of one of the adjacent element groups on one side in the sub-scanning direction and a light emitting element which is arranged at an end of the other element group on the other side in the sub-scanning direction are arranged at a same position in terms of the sub-scanning direction.

4. The exposure device according to claim 2, wherein
the light source includes element groups each having a plurality of light emitting elements which are arranged at intervals in the main scanning direction and in the sub-scanning direction,
the element groups are arranged in the sub-scanning direction, and
in the element groups adjacent to each other, a light emitting element which is arranged at an end of one of the adjacent element groups on one side in the sub-scanning direction and a light emitting element which is arranged at an end of the other element group on the other side in the sub-scanning direction are arranged at a same position in terms of the sub-scanning direction.

5. An image forming apparatus comprising:
a rotary image carrier;
the exposure device according to claim 1 that forms a latent image on a surface of the image carrier;
a developing device that develops the latent image on the surface of the image carrier into a visible image;
a transfer device that transfers the visible image on the surface of the image carrier to a medium; and
a fixing device that fixes the visible image on a surface of the medium.

6. An image forming apparatus comprising:
a rotary image carrier;
the exposure device according to claim 2 that forms a latent image on a surface of the image carrier;
a developing device that develops the latent image on the surface of the image carrier into a visible image;
a transfer device that transfers the visible image on the surface of the image carrier to a medium; and
a fixing device that fixes the visible image on a surface of the medium.

7. An image forming apparatus comprising:
a rotary image carrier;
the exposure device according to claim 3 that forms a latent image on a surface of the image carrier;
a developing device that develops the latent image on the surface of the image carrier into a visible image;
a transfer device that transfers the visible image on the surface of the image carrier to a medium; and
a fixing device that fixes the visible image on a surface of the medium.
